(19) United States
(12) Patent Application Publication
(10) Pub. No.: US 2024/0331905 A1
(43) Pub. Date: Oct. 3, 2024

(54) COIL COMPONENT

(71) Applicant: TDK Corporation, Tokyo (JP)

(72) Inventors: Manabu OHTA, Tokyo (JP); Ryo Fukuoka, Tokyo (JP); Yuji Matsuura, Tokyo (JP); Hokuto Eda, Tokyo (JP); Takahiro Nemoto, Tokyo (JP); Kenei Onuma, Tokyo (JP); Masazumi Arata, Tokyo (JP); Hitoshi Ohkubo, Tokyo (JP)

(73) Assignee: TDK Corporation, Tokyo (JP)

(21) Appl. No.: 18/617,849

(22) Filed: Mar. 27, 2024

(30) Foreign Application Priority Data
Mar. 30, 2023 (JP) 2023-056434

(51) Int. Cl. H01F 5/04; H01F 27/29

(52) U.S. Cl. CPC H01F 5/04; H01F 27/292

(57) ABSTRACT

In the coil component, the terminal electrode enters an aperture of the element body and is jointed with the bump electrode inside the element body. That is, the terminal electrode is in contact with both the bump electrode and the element body. Therefore, as compared with the case where the bump electrode is exposed to the lower surface of the element body, a joint surface of the terminal electrode is enlarged, and high adhesion of the terminal electrode is realized.

### CROSS-REFERENCE TO RELATED APPLICATIONS

This application is based upon and claims the benefit of priority from Japanese Patent Application No. 2023-56434, filed on 30 Mar. 2023, the entire content of which is incorporated herein by reference.

### TECHNICAL FIELD

The present disclosure relates to a coil component.

### BACKGROUND

In recent years, in order to mount at high-density, a lower-surface-terminal-type coil component having terminal electrodes provided only on a lower surface of an element body including a coil conductor therein has been developed. Japanese Patent Application Publication No. 2020-155510 discloses a lower-surface-terminal-type coil component including a pair of bump electrodes extending from both ends of a coil conductor and exposed from the lower surface of an element body, the pair of bump electrodes being connected to a pair of terminal electrodes provided on the lower surface of the element body.

### SUMMARY

The inventors have repeatedly studied the adhesion of the terminal electrode of the coil component, and as a result, have newly found a technique capable of enhancing the adhesion.

According to various aspects of the present disclosure, there is provided a coil component in which adhesion of a terminal electrode is improved.

A coil component according to one aspect of the present disclosure includes a substrate body having a lower surface facing a mounting element, a coil conductor disposed in the element body, a pair of bump electrodes connected to both ends of the coil conductor and extending from both ends of the coil conductor toward the lower surface of the element body along a direction intersecting the lower surface, and a pair of terminal electrodes provided on the lower surface of the element body and partially inserted into the element body to be jointed with the bump electrodes inside the element body.

In the coil component, the portion of the terminal electrode that has entered the element body is jointed with the bump electrode and comes into contact with the element body, thereby improving adhesion.

### BRIEF DESCRIPTION OF THE DRAWINGS

FIG. 1 shows a schematic perspective view of a coil component according to one embodiment.

FIG. 2 shows a cross-sectional view taken along line II-II of the coil component shown in FIG. 1.

FIG. 3 shows a plan view of the substrate of the coil component shown in FIG. 1.

FIG. 4 shows a cross-sectional view taken along line IV-IV of the coil component shown in FIG. 1.

FIG. 5 shows a cross-sectional view taken along line V-V of the coil component shown in FIG. 1.

FIG. 6 shows a cross-sectional view taken along line VI-VI of the coil component shown in FIG. 1.

FIG. 7 shows a cross-sectional view taken along line VII-VII of the coil component shown in FIG. 1.

FIG. 8 shows an enlarged view of a cross section of the coil component shown in FIG. 7.

FIG. 9 shows a diagram of the positional relationship of bump electrodes.

FIGS. 10A, 10B, and 10C show diagrams of steps of a method of manufacturing the coil component shown in FIG. 1.

FIGS. 11A, 11B, and 11C show diagrams of steps of the method of manufacturing the coil component shown in FIG. 1.

FIGS. 12A, 12B, and 12C show diagrams of steps of the method of manufacturing the coil component shown in FIG. 1.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

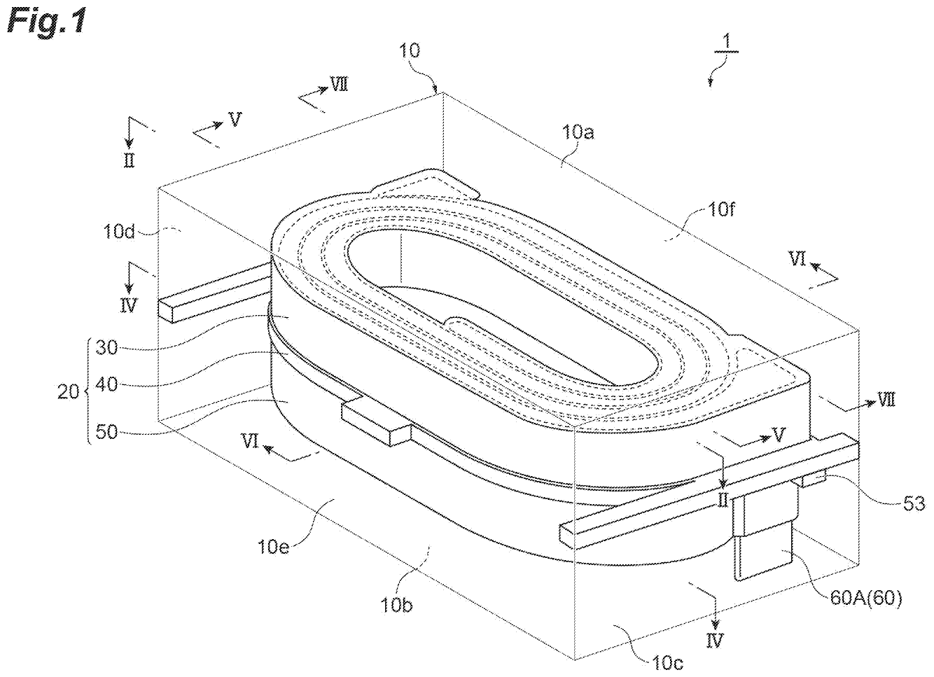

In the present embodiment, a coil component 1 will be described. The coil component 1 is a kind of electronic component. As shown in FIG. 1, the coil component 1 according to the embodiment has a rectangular parallelepiped outer shape. The coil component 1 may be designed with dimensions of a longer side 1.2 mm, a shorter side 1.0 mm, height 0.5 mm as an example. Or, the coil component 1 may be designed with dimensions of a longer side 2.0 mm, a shorter side 1.2 mm, height 0.6 mm as another example.

The coil component 1 is configured with an element body 10 and a coil portion 20 embedded in the element body 10.

The element body 10 has a rectangular parallelepiped outer shape and has six surfaces 10a to 10f. In the surfaces 10a to 10f of the element body 10, an upper surface 10a and a lower surface 10b are parallel to each other, an end surface 10c and an end surface 10d are parallel to each other, and a side surface 10e and a side surface 10f are parallel to each other. The lower surface 10b of the element body 10 is flat and has substantially no concavo-convexity, and the lower surface 10b is parallel and opposite to the mounting surface of the mounting substrate on which the coil component 1 is mounted.

The element body 10 is made of magnetic material. In the present embodiment, the element body 10 is made of magnetic metal powder-containing resin. The magnetic metal powder-containing resin is a bound powder in which magnetic metal powder is bound by a binder resin. The metal magnetic powder may be composed of, for example, an iron-nickel alloy (permalloy alloy), carbonyl iron, a FeSiCr based alloy in state of amorphous, non-crystalline, or crystalline, sendust, or the like. The binder resin is, as an example, a thermosetting epoxy resin. In the present embodiment, the content of the metallic magnetic powder in the binder powder is 80 to 92 vol % in terms of volume percent, and 95 to 99 wt % in terms of weight percent. From the viewpoint of magnetic properties, the content of the metal magnetic powder in the binder powder may be 85 to 92 vol % in terms of volume percent and 97 to 99 wt % in terms of weight percent.

The coil portion 20 is composed of a first coil body 30, a substrate 40, and a second coil body 50. In particular, the first coil body 30 is provided on a upper surface 40a of the substrate 40 located on the upper surface 10a side of the element body 10 and the second coil body 50 is provided on a lower surface 40b of the substrate 40 located on the lower surface 10b side of the element body 10. In this embodiment, the pattern shape of the first coil body 30 seen from the upper surface 40a side of the substrate 40 is the same as the pattern shape of the second coil body 50 seen from the lower surface 40b side of the substrate 40.

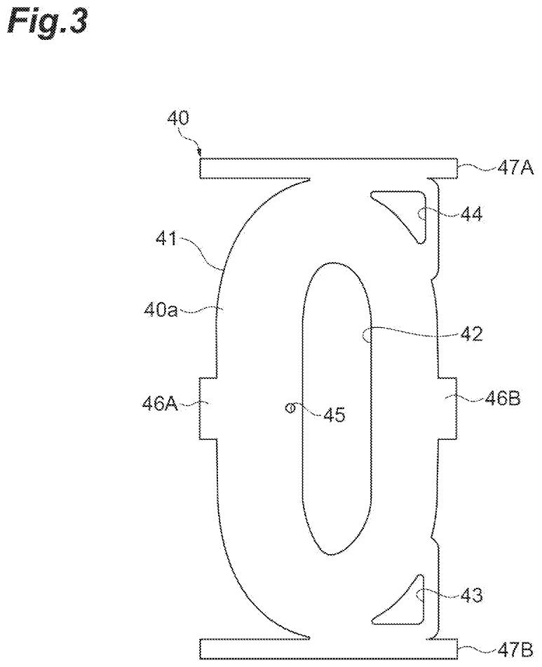

The substrate 40 is a plate-shaped member that extends parallel to the upper surface 10a and the lower surface 10b of the element body 10. The substrate 40 is positioned such that the distances between the substrate 40 and the lower surface 10b of the element body 10 and between the substrate 40 and the upper surface 10a of the element body 10 are equal. As shown in FIG. 3, the substrate 40 has an elliptical ring-shaped coil forming portion 41 extending along the long side direction of the element body 10, a pair of protruding portions 46A and 46B extending from the coil forming portion 41 to the side surface 10e and 10f in the element body 10, and a pair of frame portions 47A and 47B extending along the short side direction of the element body 10 and sandwiching the coil forming portion 41 from both sides. In the substrate 40, substantially triangular through-holes 43 and 44 are provided in areas defined by the outer periphery of the coil forming portion 41 and the pair of the frame portions 47A and 47B. Further, in the coil forming portion 41, a circular a through-hole 45 is provided at an edge portion of an oval aperture 42.

Substrate obtained by impregnating glass cloth with cyanate resin (BT resin®) and having a thickness of 60 μm can be used as the substrate 40. Other than BT resin, polyimide, aramid, or the like can be used. Ceramic or glass can also be used as the material of the substrate 40. The material of the substrate 40 may be mass-produced printed substrate material or resin material used for BT-printed substrate, FR4 printed substrate, or FR5 printed substrate.

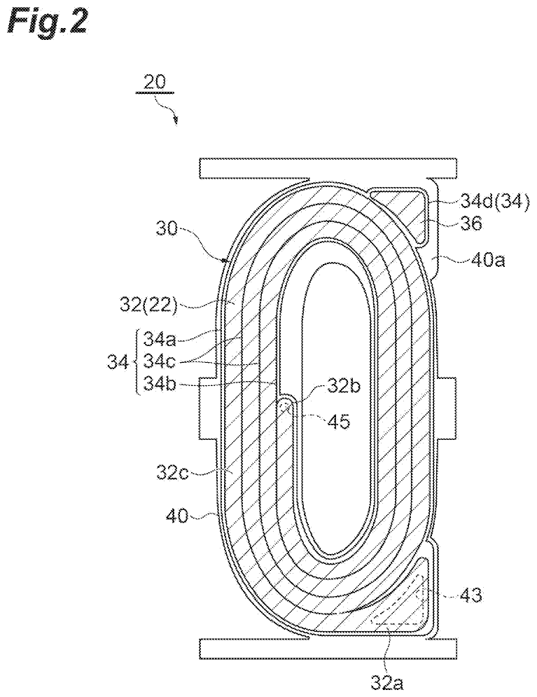

The first coil body 30 is provided on the upper surface 40a in the coil forming portion 41. As shown in FIG. 2, the first coil body 30 includes a first planar coil 32, a first insulation body 34, and a first island electrode 36, which constitute parts of a coil 22 of the coil component 1.

The first planar coil 32 is a substantially oval spiral air-core coil wound around the aperture 42 of the coil forming portion 41 in the same layer on the upper surface 40a of the substrate 40. The number of turns of the first planar coil 32 may be one or more turns. In the present embodiment, the number of turns of the first planar coil 32 is 3 to 4. The first planar coil 32 has an outer end portion 32a, an inner end portion 32b, and a first turn portion 32c connecting the outer end portion 32a and the inner end portion 32b. The outer end portion 32a is provided in an area covering the through-hole 43 of the substrate 40 when viewed from the thickness direction of the substrate 40, and has a substantially triangular shape. Specifically, the outer end portion 32a has a triangular shape with rounded corners. More specifically, the side surface on the inner peripheral side of the outer end portion 32a faces the first turn portion 32c and is curved in an arc shape along the outer peripheral surface of the first turn portion 32c. The inner end portion 32b is provided in an area covering the through-hole 45 of the substrate 40 when viewed from the thickness direction of the substrate 40, and has a circular shape. The first planar coil 32 is made of Cu, as an example, and can be formed by electrolytic plating.

The first island electrode 36 is provided in an area overlapping with the through-hole 44 of the substrate 40 when viewed from the thickness direction of the substrate 40, and has a substantially triangular shape. Specifically, the first island electrode 36 has a triangular shape with rounded corners. More specifically, the side surface on the inner peripheral side of the first island electrode 36 faces the first turn portion 32c and is curved in an arc shape along the outer peripheral surface of the first turn portion 32c. The first island electrode 36 is not in contact with the first planar coil 32 on the upper surface 40a of the substrate 40. The first island electrode 36 is a dummy electrode that is not necessary for configuring the circuit of the coil portion 20. The first island electrode 36 is made of Cu, as an example, and can be formed by electrolytic plating.

The first insulation body 34 is provided on the upper surface 40a of the substrate 40, and is a thick-film resist patterned by known photolithography. The first insulation body 34 defines a growth area for the first planar coil 32 and the first island electrode 36 and covers the first planar coil 32 in the same layer in which the first planar coil 32 is formed.

In this embodiment, the first insulation body 34 includes an outer wall 34a and an inner wall 34b that define the outline of the first planar coil 32, a partition wall 34c that separates the inner and outer turns of the first turn portion 32c of the first planar coil 32, and an outer wall 34d that defines the outline of the first island electrode 36. The first insulation body 34 is made of epoxy, as an example.

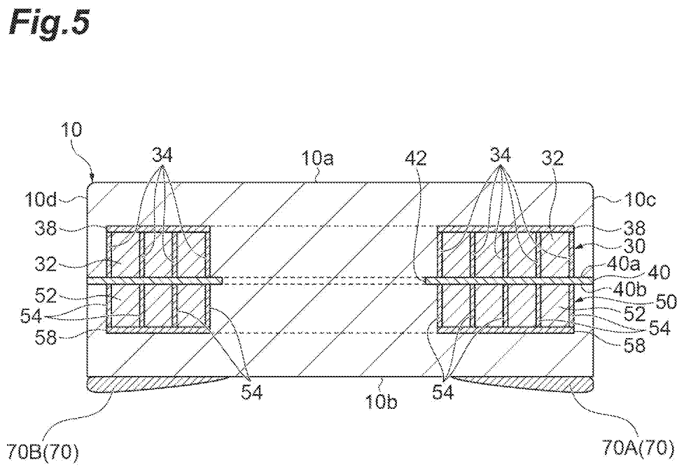

As shown in FIG. 5, the first coil body 30 further includes a protection film 38 that integrally covers the first planar coil 32 and the first insulation body 34 from the upper surface 10a side of the element body 10. The protection film 38 is made of epoxy, as an example. The protection film 38 enhances insulation between the metal magnetic powder contained in the element body 10 and the first planar coil 32.

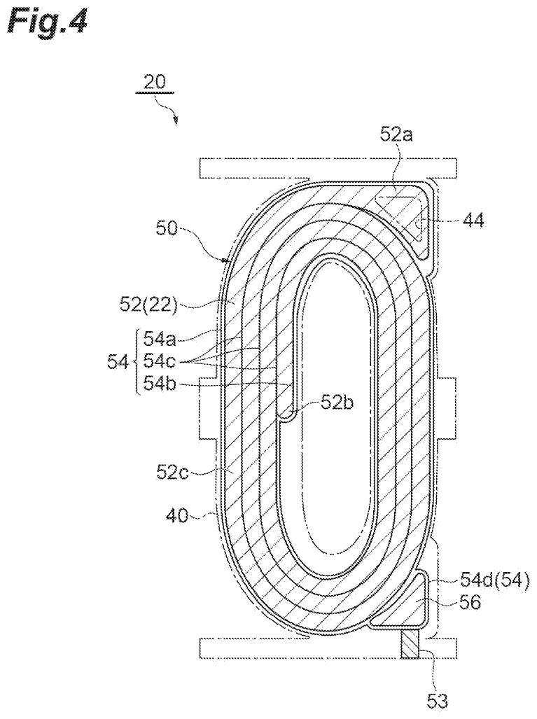

The second coil body 50 is provided on the lower surface 40b in the coil forming portion 41. As shown in FIG. 4, the second coil body 50 includes a second planar coil 52, a second insulation body 54, and a second island electrode 56, which constitute parts of the coil 22 of the coil component 1.

The second planar coil 52 is a substantially oval spiral air-core coil wound around the aperture 42 of the coil forming portion 41 in the same layer on the lower surface 40b of the substrate 40. The number of turns of the second planar coil 52 may be one or more turns. In the present embodiment, the number of turns of the second planar coil 52 is 3 to 4. The second planar coil 52 has an outer end portion 52a, an inner end portion 52b, and a second turn portion 52c connecting the outer end portion 52a and the inner end portion 52b. The outer end portion 52a is provided in an area covering the through-hole 44 of the substrate 40 when viewed from the thickness direction of the substrate 40, and has a substantially triangular shape similar to that of the outer end portion 32a of the first planar coil 32. That is, the outer end portion 52a has a triangular shape with rounded corners, and the side surface on the inner peripheral side facing the second turn portion 52c is curved in an arc shape along the outer peripheral surface of the second turn portion 52c. The inner end portion 52b is provided in an area covering the through-hole 45 of the substrate 40 when viewed from the thickness direction of the substrate 40, and has a circular shape. The second planar coil 52 is made of Cu, as an example, and can be formed by electrolytic plating.

The second island electrode 56 is provided in an area overlapping the through-hole 43 of the substrate 40 when viewed from the thickness direction of the substrate 40, and has a substantially triangular shape similar to the first island electrode 36. That is, the second island electrode 56 has a triangular shape with rounded corners, and the side surface on the inner peripheral side of the second island electrode 56 facing the second turn portion 52c is curved in an arc shape along the outer peripheral surface of the second turn portion 52c. The second island electrode 56 is not in contact with the second planar coil 52 on the lower surface 40b of the substrate 40. The second island electrode 56 is made of Cu, as an example, and can be formed by electrolytic plating.

The second insulation body 54 is provided on the lower surface 40b of the substrate 40, and is a thick-film resist patterned by known photolithography. The second insulation body 54 defines a growth area for the second planar coil 52 and the second island electrode 56 and covers the second planar coil 52 in the same layer in which the second planar coil 52 is formed. In this embodiment, the second insulation body 54 includes an outer wall 54a and an inner wall 54b that define the outline of the second planar coil 52, a partition wall 54c that separates the inner and outer turns of the second turn portion 52c of the second planar coil 52, and an outer wall 54d that defines the outline of the second island electrode 56. The second insulation body 54 is made of epoxy, as an example.

As shown in FIG. 5, the second coil body 50 further includes a protection film 58 that integrally covers the second planar coil 52 and the second insulation body 54 from the lower surface 10b side of the element body 10. The protection film 58 is made of epoxy, as an example. The protection film 58 enhances insulation between the metal magnetic powder contained in the element body 10 and the second planar coil 52.

The lower surface 40b of the substrate 40 is provided with a conductor 53 connected to the second island electrode 56. As described later, the conductor 53 functions as a power supply line when the coil 22 is formed by electrolytic plating. The conductor 53 is provided so as to cross the coil forming portion 41 and the frame portion 47B. As shown in FIG. 1, the conductor 53 is exposed from the end surface 10c of the element body 10. The conductor 53 is electrically connected to the first planar coil 32 and the second planar coil 52 via the second island electrode 56.

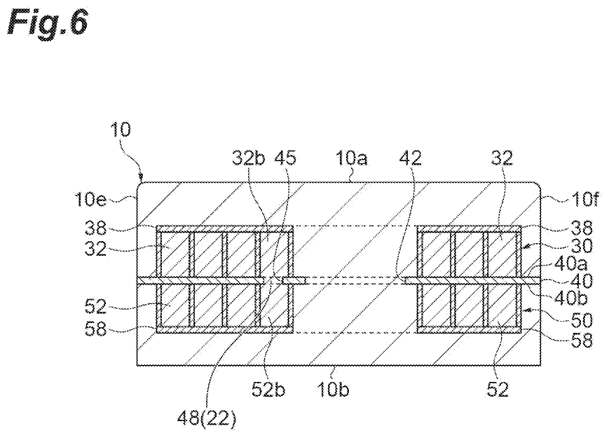

As shown in FIG. 6, the through-hole 45 in the substrate 40 is filled with a via-conductor 48. In the first planar coil 32 provided on the upper surface 40a of the substrate 40 and the second planar coil 52 provided on the lower surface 40b of the substrate 40, each of the inner end portions 32b and 52b are connected to each other via the via-conductor 48 in the through-hole 45 penetrating the substrate 40 in the thickness direction. In the present embodiment, the first planar coil 32, the second planar coil 52, and the via-conductor 48 constitute the coil 22 with air-core around the aperture 42 in the substrate 40. The coil 22 has a coil axis parallel to the thickness direction of the substrate 40 (i.e., the facing direction of the upper surface 10a and the lower surface 10b).

The first planar coil 32 and the second planar coil 52 are wound such that current flows in the same direction (i.e., the same circumferential direction when the substrate 40 is viewed from the thickness direction) when voltage is applied between both ends of the coil 22 (i.e., the outer end portion 32a of the first planar coil 32 and the outer end portion 52a of the second planar coil 52). In the present embodiment, the circumferential direction from the outer end portion 32a to the inner end portion 32b in the first planar coil 32 is clockwise as shown in FIG. 2, and the circumferential direction from the inner end portion 52b to the outer end portion 52a in the second planar coil 52 is clockwise as shown in FIG. 4. Since currents flow in the same circumferential direction in the first planar coil 32 and the second planar coil 52, generated magnetic fluxes are superposed each other and strengthen each other.

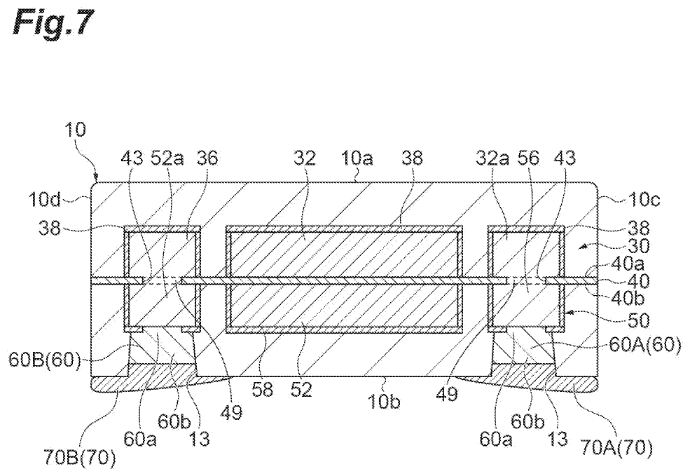

As shown in FIG. 7, the through-holes 43 and 44 in the substrate 40 are filled with via-conductors 49. The first island electrode 36 provided on the upper surface 40a of the substrate 40 and the outer end portion 52a of the second planar coil 52 provided on the lower surface 40b of the substrate 40 are connected via the via-conductor 49 in the through-hole 43 penetrating the substrate 40 in the thickness direction. Similarly, the outer end portion 32a of the first planar coil 32 provided on the upper surface 40a of the substrate 40 and the second island electrode 56 provided on the lower surface 40b of the substrate 40 are connected via the via-conductor 49 in the through-hole 44 penetrating the substrate 40 in the thickness direction.

In addition to the coil portion 20, a pair of a bump electrode 60 is embedded in the element body 10. The pair of the bump electrode 60 extends along the depth direction of the substrate 40 so as to direct both ends of the coil 22 toward the lower surface 10b of the element body 10. One bump electrode 60A has an upper end portion 60a is connected to the end portion 32a of the coil 22 via the second island electrode 56, and a lower end portion 60b extending to the vicinity of the lower surface 10b of the element body 10 but not reaching the lower surface 10b. The other bump electrode 60B has an upper end portion 60a connected to the other end portion 52a of the coil 22, and the lower end portion 60b extending to the vicinity of the lower surface 10b of the element body 10 but not reaching the lower surface 10b. Each of the bump electrodes 60A and 60B can be made of conductive material such as metal and alloy, and is formed of a Cu-plated electrode, as an example.

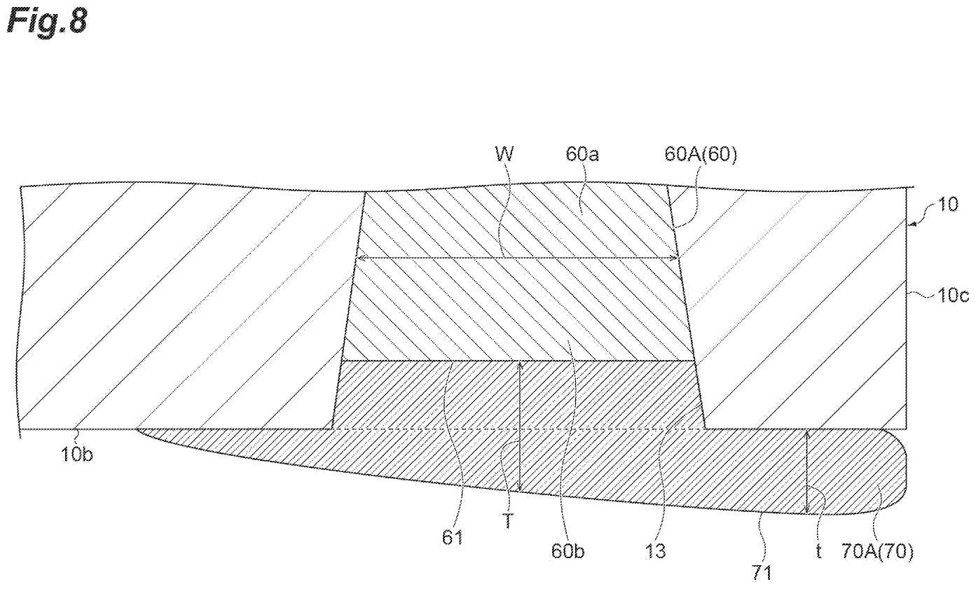

In the present embodiment, as shown in FIG. 8, at least one of the pair of the bump electrodes 60 may be configured such that at least a part of the bump electrode 60 gradually expands toward the lower surface 10b of the element body 10. In particular, the bump electrode 60 may have areas of cross-section parallel to the lower surface 10b of the element body 10 that gradually increases toward the lower surface 10b. In the cross-section shown in FIG. 8, the width W of the bump electrode 60A gradually increase over the entire length in the vertical direction.

The lower end portion 60b of each of the bump electrodes 60 does not reach the lower surface 10b of the element body 10 and remains inside the element body 10. A lower surface 61 of the lower end portion 60b of the bump electrode 60 may be a flat surface or a surface parallel to the lower surface 10b of the element body 10. There is no element body material between the lower surface 61 of each of the bump electrodes 60 and the lower surface 10b of the element body 10, and an aperture 13 is provided extending upwardly from the lower surface 10b towards the lower end portion 60b of the bump electrode 60.

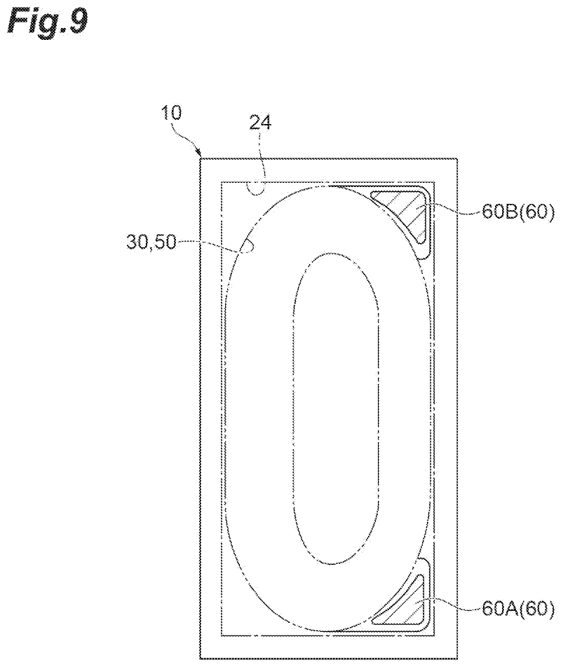

As shown in FIG. 9, each of the bump electrodes 60 is located at a corner of a rectangular area 24 including the first coil body 30 and the second coil body 50 when viewed from the thickness direction of the substrate 40. A dash-dot line in FIG. 9 is a virtual line indicating the rectangular area 24. In the present embodiment, the rectangular area 24 circumscribes the first coil body 30 and the second coil body 50 when viewed from the thickness direction of the substrate 40. Each of the bump electrodes 60 has a substantially triangular cross-sectional shape in a plane perpendicular to the thickness direction of the substrate 40.

Specifically, the cross-sectional shape of each of the bump electrodes 60 is a triangular shape along two sides defining the outer periphery of the first coil body 30 or the second coil body 50 and the corners of the rectangular area 24. For example, the bump electrode 60A has a substantially triangular cross-sectional shape along the two sides defining the corners of the rectangular area 24 and the outer periphery of the second coil body 50, and the bump electrode 60B has a substantially triangular cross-sectional shape along the two sides defining the corners of the rectangular area 24 and the outer periphery of the first coil body 30. Each of the bump electrodes 60A and 60B may have the same cross-sectional shape and the same cross-sectional dimensions throughout in the thickness direction of the substrate 40.

Each of the bump electrodes 60 does not overlap the first turn portion 32c of the first planar coil 32 and the second turn portion 52c of the second planar coil 52 in the thickness direction of the substrate 40. Specifically, none of the bump electrode 60 overlaps either the first turn portion 32c or the second turn portion 52c, at least at the upper end side (i.e., the substrate 40 side). The lower end portion 60b of the bump electrode 60 may overlap with the first turn portion 32c and/or the second turn portion 52c in the thickness direction of the substrate 40.

The through-holes 43 and 44 and the via-conductor 49 are located at the corners of rectangular area 24, similar to the pair of the bump electrodes 60. The cross-sectional shape of the via-conductor 49 (i.e., the opening shape of the through-holes 43 and 44) is a substantially triangular shape along two sides that define the outer periphery of the first coil body 30 or the second coil body 50 and the corners of the rectangular area 24, similar to the cross-sectional shape of the bump electrodes 60. The cross-sectional shape of the via-conductor 49 may be identical to or similar to the cross-sectional shape of the bump electrode 60.

The outer end portion 32a of the first planar coil 32 overlapping the through-hole 43 and the outer end portion 52a of the second planar coil 52 overlapping the through-hole 44 are also located at the corners of the rectangular area 24, similar to the through-holes 43 and 44.

The first island electrode 36 and the second island electrode 56 are located at the corners of the rectangular area 24, similar to the bump electrodes 60. Each of the first island electrode 36 and the second island electrode 56 has a substantially triangular cross-sectional shape in a plane perpendicular to the thickness direction of the substrate 40 along two sides defining the outer periphery of the first coil body 30 or the second coil body 50 and the corners of the rectangular area 24. The cross-sectional shape of the first island electrode 36 and the second island electrode 56 may be identical or similar to the cross-sectional shape of the bump electrode 60.

The lower surface 10b of the element body 10 is provided with a pair of terminal electrodes 70. The part of the pair of the terminal electrodes 70 enter the aperture 13 provided in the lower surface 10b of the element body 10 and is jointed with the bump electrodes 60, respectively. At this time, the pair of the terminal electrodes 70 is in direct contact with the lower surfaces 61 of the lower end portions 60b of the bump electrodes 60. Of the pair of the terminal electrodes 70, the terminal electrode 70A connected to the bump electrode 60A is provided in the lower surface 10b near the end surface 10c, and the terminal electrode 70B connected to the bump electrode 60B is provided in the lower surface 10b near the end surface 10d. Each of the terminal electrodes 70A and 70B is constituted by a resin electrode, and can be constituted by a resin containing Ag powder, for example.

Each of the terminal electrodes 70A and 70B has non-uniform thickness t with regard to the lower surface 10b of the element body 10. That is, the thicknesses t of the terminal electrodes 70A and 70B become thinner as the terminal electrodes 70A and 70B approach each other. The thickness t of each of the terminal electrodes 70A and 70B can be the distances between the lower surface 10b of the element body 10 and a lower surface 71 of each of the terminal electrodes 70A and 70B. For example, in the terminal electrode 70A shown in FIG. 8, the thickness is maximum in the vicinity of the end surface 10c of the element body 10, and gradually decreases (that is, monotonically decreases) as the distance from the end surface 10c increases. The thicknesses T of the portions entering the element body 10 of the terminal electrodes 70A and 70B are larger than the thicknesses t of the other portions not entering the element body 10.

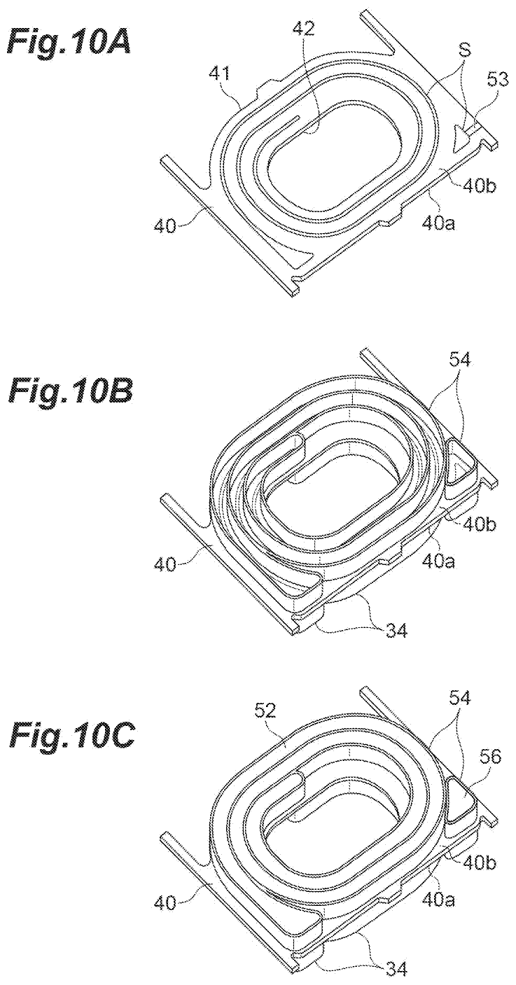

Hereinafter, a procedure for manufacturing the coil component 1 above will be described with reference to FIGS. 10A, 10B, 10C, 11A, 11B, 11C, 12A, 12B, and 12C.

When the coil component 1 is produced, the substrate 40 is prepared as shown in FIG. 10A. At this time, the substrate 40 is formed on the wafer, and a plurality of the substrate 40 are arranged in a matrix form on the wafer. A seed pattern S is formed on both surfaces 40a and 40b of the substrate 40. The seed pattern S includes patterns corresponding to each of the first planar coil 32, the first island electrode 36, the second planar coil 52, and the second island electrode 56. The lower surface 40b of the substrate 40 is provided with the conductor 53 connected to a pattern corresponding to the second island electrode 56 and connected to a power source (not shown). Further, the substrate 40 is provided with the through-holes 43, 44, and 45, and each of the through-holes 43, 44, and 45 is filled with the via-conductors 48 and 49. In FIG. 10A, the through-holes 43, 44, and 45 and the via-conductors 48 and 49 are omitted.

Then, as shown in FIG. 10B, the first insulation body 34 and the second insulation body 54 are formed on both surfaces 40a and 40b of the substrate 40. The first insulation body 34 and the second insulation body 54 can be formed by patterning a thick-film resist by known photolithography. The first insulation body 34 is formed to surround the seed pattern S corresponding to the first planar coil 32 and the first island electrode 36, and the second insulation body 54 is formed to surround the seed pattern S corresponding to the second planar coil 52 and the second island electrode 56.

Next, as shown in FIG. 10C, electrolytic plating of Cu is performed while power is supplied from the conductor 53 to the seed pattern 51 to form the first planar coil 32, the first island electrode 36, the second planar coil 52, and the second island electrode 56. At this time, the spaces defined by the first insulation body 34 and the second insulation body 54 are filled with Cu. After the electrolytic plating, surface treatment (for example, blackening treatment) of Cu exposed from the insulator can be performed as necessary. In the blackening treatment, a blackened layer (oxidized layer of Cu) is formed on the Cu plating. By forming the blackened layer whose surface is roughened, the Cu plating and the protection films 38 and 58 are strongly bonded by an anchor effect.

As long as the conductor 53 can be used for electrolytic plating of the first planar coil 32 and the second planar coil 52, the conductor 53 may be electrically connected to any one of the first planar coil 32 and the second planar coil 52, and may be electrically connected to both the first planar coil 32 and the second planar coil 52. In the present embodiment, since the conductor 53 is exposed from the surface (i.e., the end surface 10c) of the element body 10, the position of the second island electrode 56 to which the conductor 53 is connected and the position of the bump electrode 60A can be determined by checking the position where the conductor 53 is exposed from the appearance of the coil component 1.

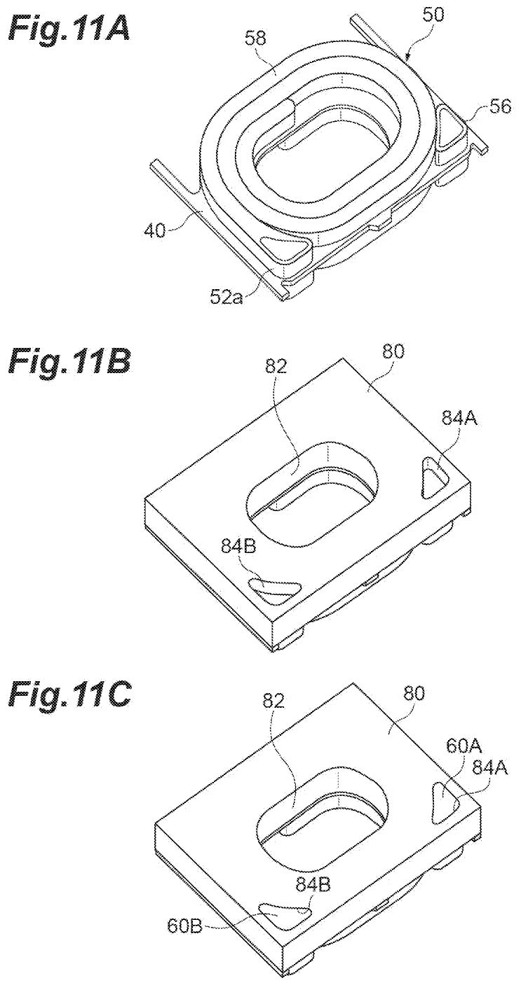

Then, as shown in FIG. 11A, the protection films 38 and 58 are formed. The outer end portion 52a and the second island electrode 56 of the second planar coil 52 where the bump electrode 60 is formed are exposed from the protection film 58 with no the protection film 58 formed (or removed after the protection film 58 is formed). When the blackening treatment is performed, the blackened layer in the outer end portion 52a and the second island electrode 56 of the second planar coil 52 in the area exposed from the protection film 58 is removed by the reducing treatment. Through the above steps, the coil portion 20 described above is obtained.

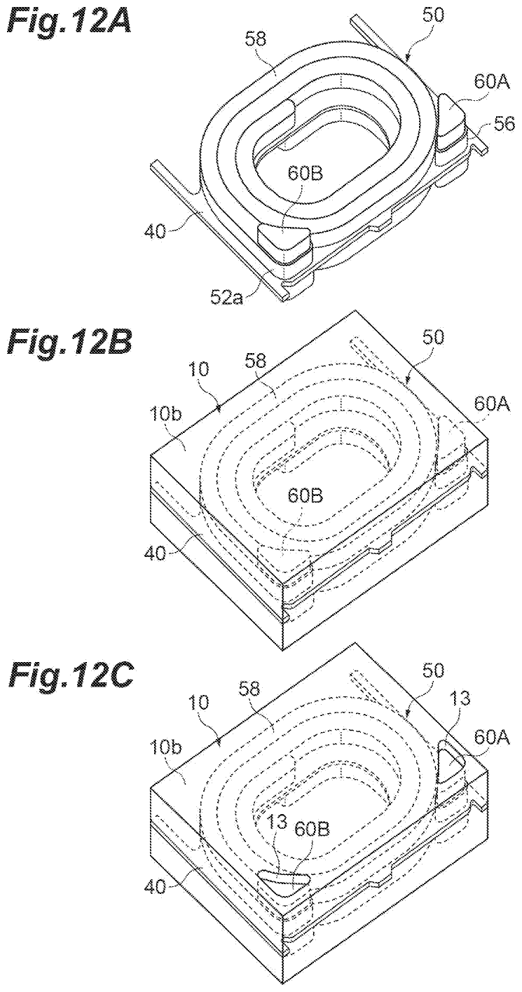

Subsequently, as shown in FIG. 11B, a thick resist 80 is formed on the lower surface 40b side of the substrate 40. The resist 80 has an aperture 82 corresponding to the aperture 42 of the substrate 40. The resist 80 also has apertures 84A and 84B corresponding to each of the areas where the bump electrodes 60 are formed (i.e., the outer end portion 52a of the second planar coil 52 and the second island electrode 56). Then, as shown in FIG. 11C, electrolytic plating of Cu is performed using the outer end portion 52a of the second planar coil 52 and the second island electrode 56 exposed from the protection film 58 in the apertures 84A and 84B of the resist 80. At this time, the internal spaces of the apertures 84A and 84B are filled with Cu, and the bump electrodes 60 are formed in the apertures 84A and 84B, respectively. Further, as shown in FIG. 12A, the resist 80 is removed to expose the bump electrodes 60.

Subsequently, as shown in FIG. 12B, the coil portion 20 and the bump electrodes 60 are integrally covered with magnetic material by a known method to constitute the element body 10. At this time, the element body 10 is designed to be thicker than the bump electrodes 60, and the bump electrodes 60 are completely embedded in the element body 10 and not exposed from the lower surface 10b. The lower surface 10b of the element body 10 is polished for planarization as necessary. Thereafter, as shown in FIG. 12C, areas corresponding to the bump electrodes 60 of the lower surface 10b of the element body 10 are etched by a known method to form the apertures 13 in the lower surface 10b and expose the bump electrodes 60 from the apertures 13. Finally, the terminal electrodes 70 having the above-described shape are formed on the lower surface 10b of the element body 10, and the wafer is divided into individual tips, thereby completing the manufacturing of the coil component 1. At this time, by applying and forming the terminal electrodes 70 of the resin electrodes on the lower surface 10b of the element body 10, the resin electrodes enter into the element body 10 from the apertures 13 of the lower surface 10b of the element body 10 and are jointed with the bump electrodes 60 exposed from the apertures 13 in the lower surface 61.

As described above, in the coil component 1, the terminal electrode 70 enters the aperture 13 of the element body 10 and is jointed with the bump electrode 60 inside the element body 10. That is, the terminal electrode 70 is in contact with both the bump electrode 60 and the element body 10 (in particular, the inner side surface of the aperture 13). Therefore, as compared with the case where the bump electrode is exposed to the lower surface 10b of the element body 10, a joint surface of the terminal electrode 70 (in particular, a surface in contact with the element body 10) is enlarged, and high adhesion of the terminal electrode 70 is realized.

The present disclosure is not limited to the above-described, and can be modified in various ways. For example, the coil is not limited to the form described above, and may be a form that does not include a substrate, for example. The coil is not limited to the elliptical annular shape described above, and may be, for example, an annular shape or a rectangular annular shape.

What is claimed is:

1. A coil component comprising:
an element body having a lower surface, the lower surface is flat and facing a mounting substrate;
a coil conductor disposed in the element body;
a pair of bump electrodes respectively connected to both ends of the coil conductor and extending from both ends of the coil conductor toward the lower surface of the element body along a direction intersecting the lower surface; and
a pair of terminal electrodes respectively provided on the lower surface of the element body; and
a pair of bump electrodes extending in a direction intersecting the lower surface and partially inserted into the element body to be respectively jointed with the pair of bump electrodes inside the element body.

2. The coil component of claim 1, wherein the terminal electrode is formed of a resin electrode.

3. The coil component according to claim 1, wherein a joint surface of the bump electrode jointed with the terminal electrode is flat.

4. The coil component according to claim 1, wherein a portion of the terminal electrode inserted into the element body is thicker than other portions of the terminal electrode.

5. The coil component according to claim 1, wherein at least a portion of the bump electrode gradually expands toward a lower surface of the element body.
